(19) United States
(12) Patent Application Publication
(10) Pub. No.: US 2025/0103316 A1
(43) Pub. Date: Mar. 27, 2025

(54) APPLYING ATTRIBUTES INTRODUCED IN FIRMWARE UPDATES

(71) Applicant: DELL PRODUCTS L.P., Round Rock, TX (US)

(72) Inventors: Santosh Gore, Bangalore (IN); Suman Lal Banik, Bangalore (IN); Sandeep Venkatesh Pai, Bengaluru (IN)

(21) Appl. No.: 18/471,863

(22) Filed: Sep. 21, 2023

(51) Int. Cl. G06F 8/65; G06F 9/4401

(52) U.S. Cl. CPC G06F 8/65; G06F 9/4403

(57) ABSTRACT

An information handling system includes a memory device and a firmware update module. The memory device includes a firmware component associated with an element of the information handling system. The firmware update module is configured receives a firmware update for the firmware component, determines that the firmware update includes a setting, stores the firmware update to the memory device, writes the setting to a non-volatile memory associated with the element, and reboots the information handling system.

### FIELD OF THE DISCLOSURE

This disclosure generally relates to information handling systems, and more particularly relates to applying attributes introduced in firmware updates in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a memory device and a firmware update module. The memory device may include a firmware component associated with an element of the information handling system. The firmware update module may be configured to receive a firmware update for the firmware component, determine that the firmware update includes a setting, store the firmware update to the memory device, write the setting to a non-volatile memory associated with the element, and reboot the information handling system.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an information handling system according to an embodiment of the current disclosure;

FIG. 2 is a flowchart illustrating a method of applying attributes introduced in firmware updates in an information handling system according to an embodiment of the current disclosure; and

FIG. 3 is a block diagram illustrating a generalized information handling system according to another embodiment of the present disclosure;

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

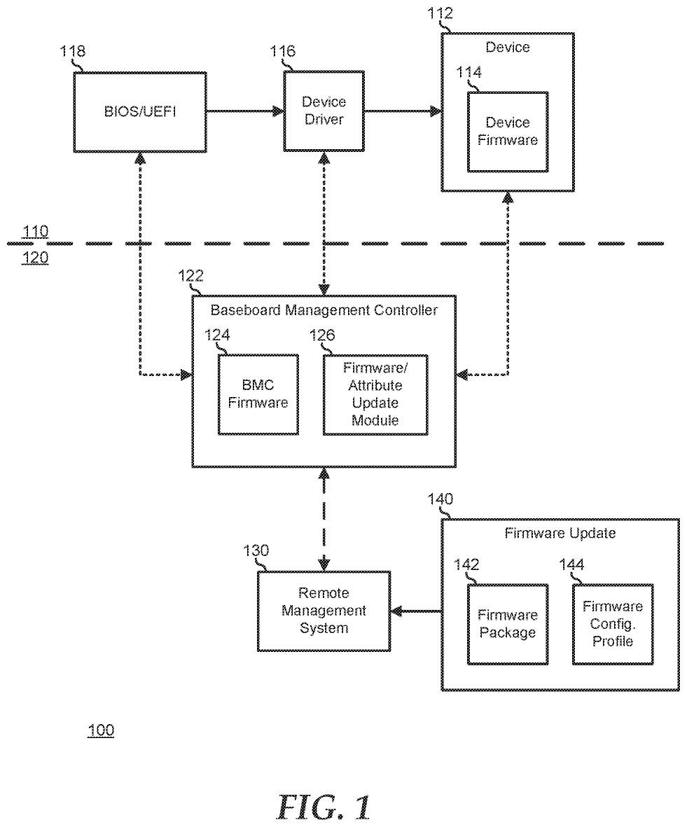

FIG. 1 illustrates an information handling system 100 that is connected to a remote management system 130. Information handling system 100 includes a host processing system 110 and a management system 120. Host processing system 110 represents the hardware, firmware, operating systems, applications, and other elements typical of an information handling system such as information handling system 300 as described below. In this regard, host processing system 110 provides the data processing functions and features as are typically associated with a computer device, such as a laptop computer, a workstation, an element of datacenter equipment, a mobile device such as a cell phone or tablet device, or any other type of computing device, as needed or desired. Host processing system 110 includes hardware elements, as generally illustrated by a device 112, and firmware elements, as generally illustrated by device firmware 114 associated with the device, a device driver 116 associated with the device, and a basic input/output system/universal extensible firmware interface (BIOS/UEFI) 118 associated generally with the host processing system.

Management system 120 represents a processing system instantiated on information handling system 100 that is separate from, and operates out-of-band from, host processing system 110. Management system 120 includes hardware elements, as generally illustrated by a baseboard management controller (BMC) 122, and firmware elements, as generally illustrated by BMC firmware 124. BMC 122 includes a firmware/attribute update module 126, and is connected to remote management system 130. Management system 120 operates to monitor, manage, and maintain the operational state of information handling system 100. In particular, management system 120 operates to monitor, manage, and maintain the operational state of the firmware elements of information handling system 100, including device firmware 114, device driver 116, BIOS/UEFI 118, and BMC firmware 124.

Information handling system 100 may include additional firmware elements. In particular, host processing system 110 may include one or more device in addition to device 112, and that any such additional devices may include associated firmware and drivers, as needed or desired. Similarly, management system 120 may include other elements in addition to BMC 122, and any such additional elements may include associated firmware. Thus as used herein, the term “firmware elements” includes one or more of device firmware 114, device driver 116, BIOS/UEFI 118, BMC firmware 124, and any other firmware instantiated on information handling system 100, as needed or desired.

In monitoring the firmware elements of information handing system 100, management system 120 utilizes various management communication interfaces with the elements of the information handling system to track the operational state, including the settings and configurations, of the firmware elements. Examples of management communication interfaces may include various low-speed data communication interfaces, such as an Inter-Integrated Circuit (I2C) interface or Improved I2C (I3C) interface, a System Management Bus (SMBus), a Serial Presence Detect (SPD) interface, a Serial Peripheral Interface (SPI), or the like. Other examples of management communication interfaces may include various Host-to-BMC interfaces, as needed or desired. Information related to the monitoring of the firmware elements are utilized by BMC 122 to provide management of the firmware elements, as described further below. The monitoring information is also provided to remote management system 130, as needed or desired, and the remote management system may utilize the monitoring information to implement various policies or operational states on information handling system 100 or on additional information handling systems, as needed or desired. The details of monitoring the operational state of the firmware elements of an information handling system by a management system are known in the art and will not be described further herein, except as may be needed to illustrate the current embodiments.

In managing the firmware elements of information handling system 100, management system 120 communicates with the elements of the information handling system to manipulate the settings and configurations of the firmware elements. In this regard, the firmware elements include various settings that influence the operations of the associated system, and that can be set in one of a number of different states. For example, BIOS/UEFI 118 may include an optional user interface that permits a user of information handling system 100 to interact with the various setting to configure the information handling system as desired by the user. Management system 120 may operate alternatively to execute the user interface via, for example, a script, to manipulate the settings, or to directly manipulate the settings in a non-volatile memory device associated with the storage of the settings by BIOS/UEFI 118. Management system 120 may manipulate the settings and configurations in order to optimize the operations of information handling system 100, to secure the operations, to implement various policies related to the operations, or to otherwise change the settings, as needed or desired. The details of managing the operational state of the firmware elements of an information handling system by a management system are known in the art and will not be described further herein, except as may be needed to illustrate the current embodiments.

In maintaining the firmware elements of information handling system 100, management system 120 communicates with the elements of the information handling system, and particularly with non-volatile memory devices associated with the firmware elements, to store, recover, update, or otherwise manipulate the underlying code of the firmware elements, as needed or desired. For example, management system 120 may receive a firmware updated firmware code for a particular firmware element from remote management system 130, and execute update procedures on the firmware element to replace existing firmware code with the updated firmware code. In another example, a firmware code associated with a particular firmware element may have become corrupted. Management system 120 may recover or restore the original firmware code for the firmware element. The details of maintaining the firmware code of an information handling system by a management system are known in the art and will not be described further herein, except as may be needed to illustrate the current embodiments.

It has been understood by the inventors of the current disclosure that the management of the firmware elements of an information handling system is typically accompanied by a subsequent operation of maintaining of the firmware elements. In particular, firmware updates may typically be provided in association with new functions or features of the associated hardware or the operating system of the information handling system, with new security functions or features or newly discovered security holes, with enhanced performance capabilities of functions or features, or the like. Such new functions and features are typically enabled by new settings that enable the functions and features. Thus, the maintenance step (that is, the storing of new firmware updates) is followed by a management step (that is, the changing of the new settings). In typical practice, an update to a firmware element necessitates a reboot of the information handling system, and a change to the settings of the firmware element necessitates a second reboot of the information handling system.

Such successive reboots of the information handling system are not desirable because they require significant amounts of time to execute, particularly in an enterprise environment where large memory subsystems need to be initialized, multiple I/O interfaces need to be configured, complex network structures need to be implemented, or the like. Moreover, in the enterprise environment, such successive reboots result in significant “down-time” for the resources of the enterprise, particularly when multiple systems need to be updated at the same time. Also, in the consumer environment, a user typically remains attentive to the process through the entirety of the multiple reboots to ensure that the proper settings are enacted and that the entire process is performed successfully. Thus it remains desirable to be able to perform firmware updates and setting changes with a single reboot of the information handling system.

In a particular embodiment, a firmware configuration profile (FCP) is provided in conjunction with a firmware update. As illustrated, a firmware update 140 is provided to remote management system 130 for implementation on information handling system 100 by management system 120. Firmware update 140 includes a firmware package 142 and a FCP file 144. Firmware package 142 represents the firmware update code as may be typically associated with a firmware update. As such, firmware package 140 may represent a firmware update for any firmware element of information handling system 100, including at least one of device firmware 114, device driver 116, BIOS/UEFI 118, BMC firmware 124, or another firmware element of the information handling system, as needed or desired.

FCP file 144 represents metadata associated with firmware package 142 that includes attributes that are ascribed to the firmware package, desired states for the attributes to retain upon completion of the firmware update process, and dependencies associated with the attributes and the firmware package. In a particular sense, an attribute may be understood to equate to a setting or configuration that is available in firmware package 142. However more broadly, an attribute may relate to other conditions of the firmware package or the device to which firmware update 140 is related. For example in addition to a setting or configuration attribute, an attribute can ascribe identification information to the device, such as a Fully Qualified Device Descriptor (FQDD) or Fully Qualified Device Name (FQDN), a logical path associated with the device, a content path, or other information not directly related to operational conditions of the device itself, as needed or desired.

The attributes may be associated with one or more dependency that governs the implementation of the associated attributes. The dependencies may relate to requirements for the implementation of the associated attributes, to recommendations associated with the attributes, or the like. In particular, requirements may relate to associate attributes within firmware package 142 that need to be enabled together, attributes that need to be disabled in order to enable the particular attribute, devices which must or must not be present on information handling system 100 before enabling the particular attribute, other firmware or firmware versions which must or must not be present on the information handling system before enabling the particular attribute, or the like. An example of a dependency may include where a particular BIOS/UEFI version must be present before a device operating mode is enabled.

An example of firmware package 142 is shown below:

```
<Firmware_Update FQDD=″Disk.Virtual.0:RAID.Integrated.1□1″>
    . . .
  <Packages>
    <Package Id=″Bios_win_1_4_3″ OSCode=″Win64″ PlatformID=″094A″>
      <Content path=″BIOS_22WKK_WN64_1.4.3.EXE″ RebootRequired=”true”/>
    </Package>
  . . .
  </Packages>
  . . .
```

An example of FCP file 144 is shown below:

```
<Firmware_Update FQDD=″Disk.Virtual.0:RAID.Integrated.1□1″>
...
  <Attribute Name=″BootVD″>True</Attribute>
  <Attribute Name=″RAIDinitOperation″>None</Attribute>
  <Attribute Name=″DiskCachePolicy″ minVersionRequired=″2.0″ >Default</Attribute>
    <Attribute Name=″Secure Memory Encryption” Group=″SecuredCore″ Value=”Enabled”>
    <Dependency>
      <Package Id=″Bios_win_1_4_3″ MinVersionRequired=″1.4.3″/>
    </Dependency>
    <Attribute Name=″RAIDdefaultWritePolicy″>WriteBack</Attribute>
    <Attribute Name=″RAIDdefaultReadPolicy″>ReadAhead</Attribute>
. . .
```

Firmware/attribute update module 126 operates to import firmware update 140 and to install the update to the associated firmware element. The importation of firmware update 140 may be in response to a push of the firmware update from remote management system 130, in response to a user requested firmware update process, such as to install an new firmware version, to replace a firmware element, to recover a firmware element, or the like. When firmware update 140 is imported, firmware/attribute update module 126 operates to evaluate FCP file 144 to determine what, if any, dependencies are provided by the FCP file. If FCP file 144 exhibits any dependencies, firmware/attribute update module 126 operates to attempt to resolve the dependencies.

For example, if a dependency relates to the presence or absence of a particular BIOS/UEFI revision level, firmware/attribute update module 126 operates to verify the BIOS/UEFI revision level, and if necessary, to perform an update to BIOS/UEFI 118 to bring the BIOS/UEFI into conformance with the dependency before installing firmware package 142. In another example, if a dependency relates to the presence or absence of a hardware device, firmware/attribute update module 126 operates to check for the presence of the hardware device. If the hardware device is present, then firmware/attribute update module 126 installs firmware package 142. However if the hardware device is not present, then firmware/attribute update module 126 provides an indication that the particular attribute cannot be implemented due to the absence of the hardware device.

When all dependencies included in FCP file 144 are cleared, then firmware/attribute update module 126 operates to install firmware package 142. The process of updating firmware elements by a firmware updater are known in the art and will not be further described herein, except as may be needed to illustrate the current embodiments. After firmware package is installed, firmware/attribute update module 126 forgoes the reboot of information handling system 100, as may be typical of a firmware updater. Rather, firmware/attribute update module 126 operates to implement the attributes found in FCP file 144. In particular, any settings or configurations found in the attributes of FCP file 144 are stored to the non-volatile memory location associated with the settings and configurations for the firmware element associated with firmware update 140. Only after storing the settings and configurations defined by the attributes found in FCP file 144 does firmware/attribute update module 126 operate to reboot information handling system 100. In this way, firmware/attribute update module 126 streamlines the firmware update process by eliminating multiple reboot cycles.

In a particular embodiment, BIOS/UEFI 118 includes a firmware update module that operates to implement the firmware update process, including firmware recovery, firmware replacement, and the like. In this embodiment, the firmware update module of BIOS/UEFI 118 includes an attribute update module similar to attribute update module 126, as described above. In this way, a user of information handling system 100 may incorporate a firmware update similar to firmware update 140 out of a BIOS user interface, such as a firmware update interface, as needed or desired. The firmware update interface may include a FCP editor that permits the user to set the firmware attributes prior to the implementation of the firmware update. Then the attribute update module instantiated by BIOS/UEFI 118 operates to evaluate the attributes and any dependencies, to resolve the dependencies, and to perform the firmware update, as described above.

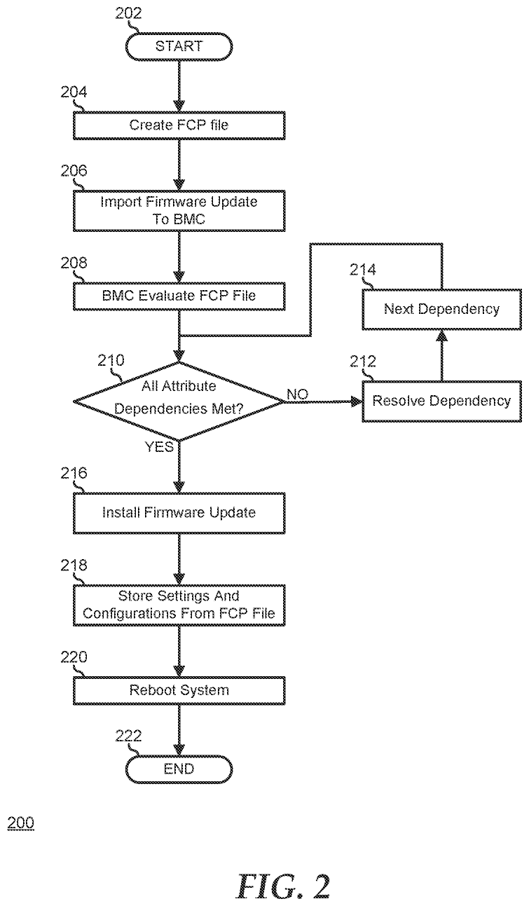

FIG. 2 illustrates a method 200 of applying attributes introduced in firmware updates for a device in an information handling system starting at block 202. A user or system administrator creates a FCP file for a firmware update in block 204. The firmware update including the FCP file is imported to a BMC in block 206, and the BMC evaluates the FCP file in block 208. A decision is made as to whether or not all dependencies associated with the identified attributes in the FCP file have been met in decision block 210. If not, the “NO” branch of decision block 210 is taken, the unresolved dependency is resolved in block 212, a next dependency is identified in block 214, and the method loops back to decision block 210. When all of the dependencies are resolved, the “YES: branch of decision block 210 is taken, and the firmware update is installed in the information handling system in block 216. The settings and configurations identified by the attributes in the FCP file are stored to the non-volatile memory associated with the device in block 218, the BMC reboots the information handling system in block 220, and the method ends in block 222.

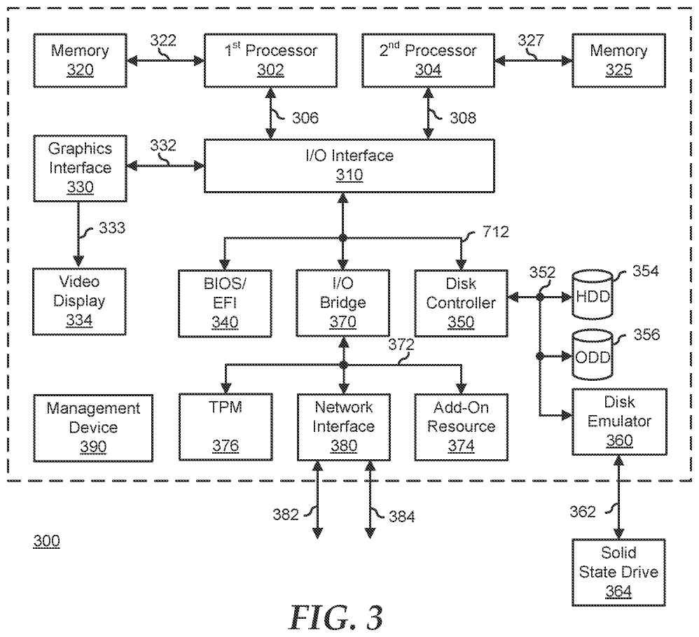

FIG. 3 illustrates a generalized embodiment of an information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 364, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 364, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 325 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 2394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a memory device including a firmware component associated with an element of the information handling system; and
a firmware update module configured to:
receive a firmware update for the firmware component;
determine that the firmware update includes a setting;
store the firmware update to the memory device;
write the setting to a non-volatile memory associated with the element; and
reboot the information handling system.

2. The information handling system of claim 1, further comprising a baseboard management controller.

3. The information handling system of claim 2, wherein the baseboard management controller includes the firmware update module.

4. The information handling system of claim 2, wherein the baseboard management controller receives the firmware update from a remote management system.

5. The information handling system of claim 1, wherein the firmware update includes a setting file that includes the setting.

6. The information handling system of claim 5, wherein the setting file includes a dependency associated with the setting.

7. The information handling system of claim 6, wherein the firmware update module is further configured to resolve the dependency prior to storing the firmware update to the memory device.

8. The information handling system of claim 1, wherein the element of the information handling system includes a basic input/output system (BIOS) of the information handling system.

9. The information handling system of claim 8, wherein the BIOS includes the firmware update module.

10. The information handling system of claim 1, wherein the element of the information handling system includes a device of the information handling system.

11. A method, comprising:
providing, on an information handling system, a memory device including a firmware component associated with an element of the information handling system;
receiving, by a firmware update module, a firmware update for the firmware component;
determining that the firmware update includes a setting;
storing the firmware update to the memory device;
writing the setting to a non-volatile memory associated with the element; and
rebooting the information handling system.

12. The method of claim 11, further comprising providing, on the information handling system, a baseboard management controller.

13. The method of claim 12, wherein the baseboard management controller includes the firmware update module.

14. The method of claim 12, wherein the baseboard management controller receives the firmware update from a remote management system.

15. The method of claim 11, wherein the firmware update includes a setting file that includes the setting.

16. The method of claim 15, wherein the setting file includes a dependency associated with the setting.

17. The method of claim 16, further comprising resolving the dependency prior to storing the firmware update to the memory device.

18. The method of claim 11, wherein the element of the information handling system includes a basic input/output system (BIOS) of the information handling system.

19. The method of claim 18, wherein the BIOS includes the firmware update module.

20. An information handling system, comprising:
a memory device including a firmware component associated with an element of the information handling system; and
a firmware update module configured to:
receive a firmware update for the firmware component, the firmware update including a firmware package and a firmware configuration profile file;
determine that the firmware configuration profile includes a setting;
store the firmware update to the memory device;
write the setting to a non-volatile memory associated with the element; and
reboot the information handling system.
